(19) United States
(12) Patent Application Publication
(10) Pub. No.: US 2026/0116222 A1
(43) Pub. Date: Apr. 30, 2026

(54) MODULAR SCALABLE PLATFORM ZONAL ARCHITECTURE PACKAGING

(71) Applicant: Rivian IP Holdings, LLC, Irvine, CA (US)

(72) Inventors: Sanjeewa Keven SUGATAPALA, Long Beach, CA (US); Kyle LOBO, Westchester, CA (US); Vidya RAJAGOPALAN, Palo Alto, CA (US); Chintan SHARMA, Irvine, CA (US); Joseph Daniel HIMMELHEBER, Redondo Beach, CA (US); Long Phi HUYNH, Brea, CA (US)

(21) Appl. No.: 19/218,040

(22) Filed: May 23, 2025

Related U.S. Application Data
(60) Provisional application No. 63/712,990, filed on Oct. 28, 2024.

(51) Int. Cl. B60L 50/60; B60K 1/04; B60L 50/64; B60R 16/023; H02J 1/10

(52) U.S. Cl. CPC B60L 50/66; B60K 1/04; B60L 50/64; B60R 16/0239; H02J 1/10; B60K 2001/0433; B60L 2210/10; H02J 2105/37

(57) ABSTRACT

An integrated power management system for electric vehicles utilizes a centralized power management compartment architecture. The power management compartment, located under the second-row seat, houses components including a central electronic control unit (ECU), an energy management module (EMM) with direct current to direct current (DC-DC) converter, and a low voltage battery. This centralized architecture features direct battery connection, unified grounding, and integrated control units, reducing system complexity, improving packaging efficiency, and enhancing serviceability compared to conventional distributed power management systems.

### CROSS-REFERENCE TO RELATED APPLICATIONS

The present application claims the benefit of U.S. Provisional Application No. 63/712,990, entitled “Adaptive Hardware Safety Disconnect System”, filed Oct. 28, 2024, the entirety of which is incorporated herein for reference.

### INTRODUCTION

This application is directed to power and feature management systems for electric vehicles, such as zonal integrated energy storage and distribution architecture that combine multiple components into a crash protected area.

### SUMMARY

The disclosed subject matter provides for zonal architecture for power distribution and other designs thereof that may allow for redundancy in power distribution and feature functionality, while efficiently integrating power management components in a location.

### BRIEF DESCRIPTION OF THE DRAWINGS

Certain features of the subject technology are set forth in the appended claims. However, for purpose of explanation, several examples of the subject technology are set forth in the following figures.

FIG. 1A illustrates an example overhead view of a vehicle with zonal power distribution as described herein.

FIG. 1B illustrates an example side view of a vehicle with zonal power distribution as described herein.

FIG. 2A illustrate an example block diagram that may include a plurality of ECUs of vehicle ECUs.

FIG. 2B illustrates an example block diagram that may include a plurality of ECUs of vehicle ECUs.

FIG. 3A illustrates an example perspective cross-sectional view of a rear seat assembly and power management compartment.

FIG. 3B illustrates an example perspective cross-sectional view of a rear assembly and power management compartment.

FIG. 3C illustrates an example perspective cross-sectional view of a rear assembly and power management compartment.

FIG. 3D illustrates an example perspective cross-sectional view of a rear assembly and power management compartment.

FIG. 3E illustrates an example implementation of a busbar associated with the power management compartment.

FIG. 3F illustrates an example schematic representation of the power distribution system.

FIG. 4 illustrates an example zonal architecture with a treehouse component.

FIG. 5 illustrates an example configuration of rear assembly.

### DETAILED DESCRIPTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, it will be clear and apparent to those skilled in the art that the subject technology is not limited to the specific details set forth herein and may be practiced without these specific details. In some instances, well-known structures and components are shown in block diagram form in order to avoid obscuring the concepts of the subject technology.

Conventional electric vehicle power systems often use distributed components, leading to increased complexity, wiring, and reduced reliability. There is a need for more integrated and centralized architectures to improve efficiency, reduce costs, enhance safety, or provide functional redundancy. Current systems often struggle with optimal power distribution, safety during charging, or efficient packaging of components.

The disclosed subject matter provides an integrated power management system for electric vehicles centered around a power management compartment (herein referenced as treehouse) configuration. The power management compartment may integrate multiple power management components in a centralized location, typically under the rear seat or in the trunk area of the vehicle. This may allow for simplified wiring, reduced connection points, or more efficient use of space compared to conventional distributed architectures.

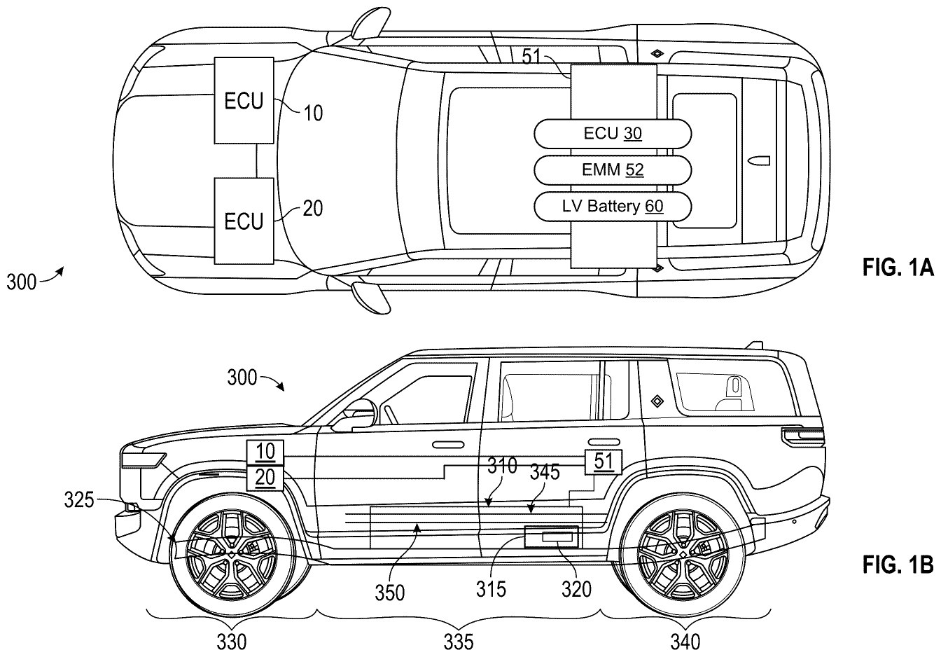

FIG. 1A illustrates an example overhead view of vehicle 300. As further described herein, vehicle 300 may include electronic control units (ECUs) in front portion 330 of vehicle 300 (e.g., ECU 10 and ECU 20), an ECU in rear portion 340 of vehicle 300 (e.g., ECU 30), power management compartment 51, or low voltage (LV) battery 60 (e.g., 12V battery), among other things. As further described herein, ECU 10 may operate components on a first side of a longitudinal axis of vehicle 300, while the ECU 20 may operate components on a second side of the longitudinal axis. The longitudinal axis may be defined as an imaginary line running from the front of vehicle 300 to the rear along its center, dividing vehicle 300 into the first (e.g., left) and second (e.g., right) sides. ECU 30 may operate components at the rear of vehicle 300. ECU 30 may be located within power management compartment 51.

Power management compartment 51 may include ECU 30, energy management module (EMM) 52, or LV battery 60 (e.g., 9V to 16V), among other components. Power management compartment 51 may be a structure that includes power management related components located in a rear of vehicle 300, such as under the second row seat or trunk of vehicle 300. Power management compartment 51 may be the volume of a traditional gas tank and package multiple components as disclosed herein. Power management compartment 51 components may include ECU 30 with left and right MCUs (e.g., MCU 65 or MCU 66), a direct current to direct current (DC-DC) converter (e.g., DC-DC 50), LV battery 60, or an isolation switch (ISOSW) (e.g., fault isolation system 11), among other things. DCDC 50 may be located within EMM 52. ECU 30 may integrate battery management system (BMS) and zonal control functions, managing power distribution between the DC-DC bus and battery bus. Power management compartment 51 may connect with ECU 10 and ECU 20, forming the backbone of the vehicle's power architecture. This design may reduce high current feeds from 7 or more in other architectures to just 3, for example, in the disclosed architecture, while eliminating the need for diode ORing, among other things. Power management compartment 51 architecture may provide end-to-end functional redundancy and may enable simplified LV battery management through a single battery feed. This approach may allow for more efficient packaging and reduced system complexity.

FIG. 1B illustrates an example side view of vehicle 300. As shown, the vehicle 300 may include one or more battery packs, such as high voltage (HV) battery pack 310 (e.g., 450V), which may be located near the center body portion 335 of vehicle 300. HV battery pack 310 may be coupled with one or more electrical systems of the vehicle 300 to provide power to the electrical systems. As further described herein, ECU 10 (also may be referred to herein as east zone controller—EZC 10), ECU 20 (also may be referred to herein as west zone controller—WZC 20), or ECU 30 (also may be referred to herein as south zone controller—SZC 30) may be communicatively connected with or have power distributed with each other and may be functionally redundant for power or other operations of electronic components of vehicle 300.

In one or more implementations, vehicle 300 may be an electric vehicle having one or more electric motors that drive wheels of the vehicle 300 using electric power from HV battery pack 310. In one or more implementations, vehicle 300 may also, or alternatively, include one or more chemically-powered engines, such as a gas-powered engine or a fuel cell powered motor. For example, electric vehicles can be fully electric or partially electric (e.g., hybrid or plug-in hybrid). In various implementations, vehicle 300 may be a fully autonomous vehicle that can navigate roadways without a human operator or driver, a partially autonomous vehicle that can navigate some roadways without a human operator or driver or that can navigate roadways with the supervision of a human operator, may be an unmanned vehicle that can navigate roadways or other pathways without any human occupants, or may be a human operated (non-autonomous) vehicle configured for a human operator.

In the example of FIG. 1B, the vehicle 300 may be implemented as a truck (e.g., a pickup truck) having a battery pack 310. As shown, HV battery pack 310 may include one or more battery modules 315, which may include one or more battery cells 320. However, this is merely illustrative and, in other implementations, HV battery pack 310 may be provided without any battery modules 315 (e.g., in a cell-to-pack configuration).

As shown in FIG. 1B, vehicle 300 may include a support structure such as a chassis 325 (e.g., a frame, internal frame, or other support structure). The chassis 325 may support various components of the vehicle 300. As shown, the chassis 325 may span a front portion 330 (e.g., a hood or bonnet portion), center body portion 335, and a rear portion 340 (e.g., a trunk, payload, or boot portion) of the vehicle 300 in some implementations. In one or more implementations, HV battery pack 310 may be installed on the chassis 325 (e.g., within one or more of the front portions 330, center body portion 335, or the rear portion 340). As shown, HV battery pack 310 may include or be electrically coupled with one or more one busbars (e.g., one or more current collector elements). In the example of FIG. 1B, vehicle 300 includes a first busbar 345 and a second busbar 350, either or both of which may include electrically conductive material to connect or otherwise electrically couple battery module(s) 315 or the battery cell(s) 320 with other electrical components of vehicle 300 to provide electrical power to various systems or components of vehicle 300.

In other implementations, vehicle 300 may be implemented as another type of electric truck, an electric delivery van, an electric automobile, an electric car, an electric motorcycle, an electric scooter, an electric passenger vehicle, an electric passenger or commercial truck, a hybrid vehicle, or other vehicles such as sea or air transport vehicles, planes, helicopters, submarines, boats, or drones, or any other movable apparatus having a battery pack 310 (e.g., that powers the propulsion or drive components of the moveable apparatus).

The disclosed multi-zonal architecture may allow for reduced wiring when compared to other architectures. Shorter wires may provide for less mass and therefore vehicle 300 may weigh less. While wire length generally may not significantly affect cost for small gauge wires, it may influence the overall mass and flexibility of the harness. Longer wires may increase harness bulk, potentially complicating installation due to reduced flexibility.

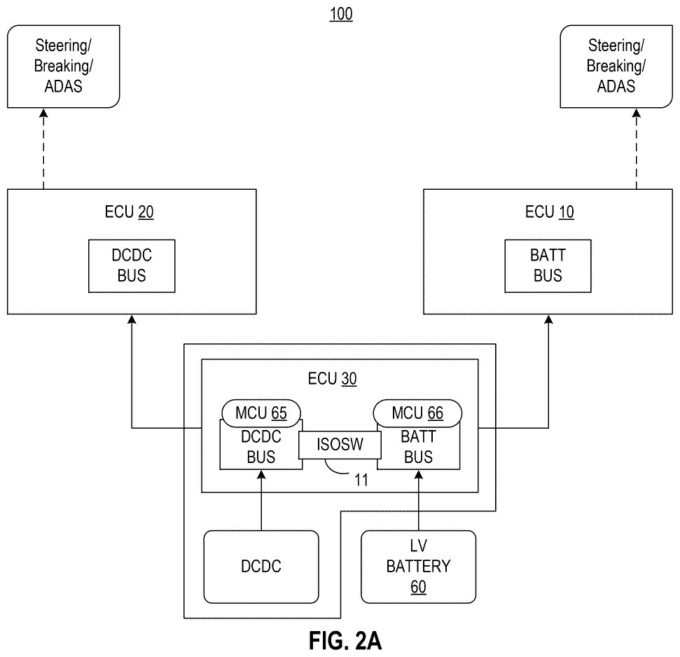

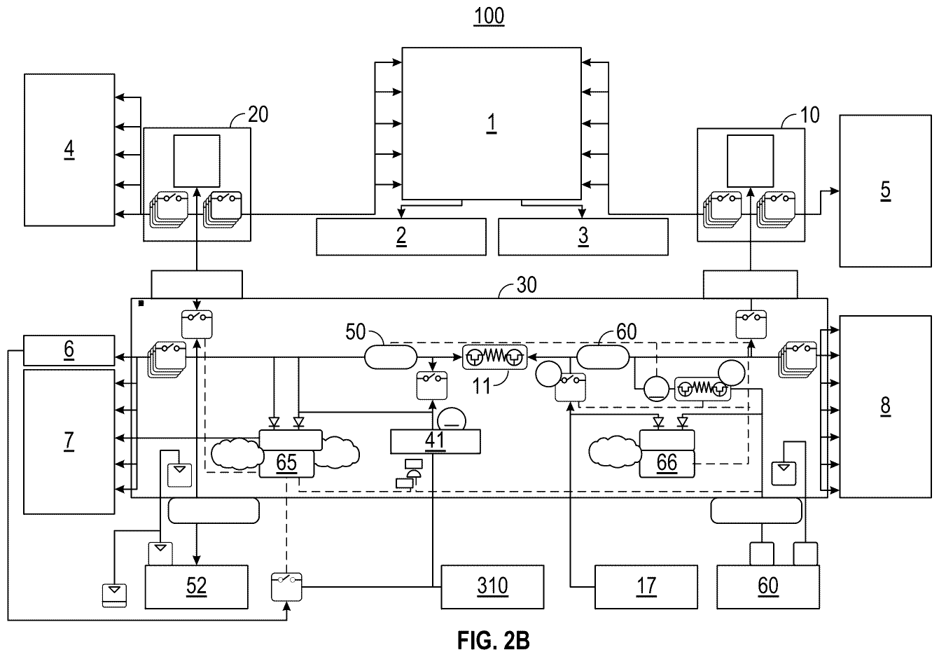

FIG. 2A and FIG. 2B illustrate exemplary block diagrams of system 100 that may include a plurality of ECUs of vehicle 300. An ECU is an embedded system that may control one or more of the electrical systems or subsystems in a vehicle. The positioning and connections of ECU 10, ECU 20, or ECU 30 may provide for a level of redundancy for faults, which may be caused by collisions or other malfunctions. The design of system 100 may allow vehicle 300 to safely operate for a period after the fault, such as being able to drive vehicle 300 (e.g., steer, brake, or accelerate) to a safe position off of a roadway or being able to operate electronic controlled functions (e.g., door latches) of vehicle 300, among other things. As shown, ECU 10, ECU 20, or ECU 30 may be connected with DCDC 50 (also referred herein as DCDC bus 50) to operate DCDC loads and a low voltage (LV) battery 60 (e.g., 12V battery or LV battery bus 60) to operate LV battery loads.

FIG. 2B illustrates an exemplary block diagram of system 100 in normal operation. In an example, one or more ECUs (e.g., ECU 30) may include a fault isolation system 11. Fault isolation system 11 may include an isolation switch. In some configurations, in consideration of safety, only one ECU (e.g., ECU 30) may include fault isolation system 11. There may be a common bus that allows for bidirectional power to be transmitted to and from LV battery 60 that may be a function of using fault isolation system 11. In the event of a failure of the DCDC 50 (within EMM 52) or LV battery 60, the common bus will retain operation (e.g., will be available).

With continued reference to FIG. 2B, each ECU may have on or more dedicated functions that may be powered by DCDC 50, LV battery 60, or LV DCDC 41. ECU 10 may operate or connect with (e.g., communication or power) functions 1, functions 2, functions 3, and functions 5. Functions 1 may include functions such as first row universal serial bus, or electronic stability program (ESP), among other things. Functions 2 may include functions such as right door latch, passenger seat motor, right headlamp, alarm module, or frunk latch, among other things. In this example, functions 1, functions 2, functions 3, or functions 5 of ECU 10 may be powered by DCDC 50 (which may be the primary power) or LV battery 60 (which may be the secondary power). ECU 10 may be located on the right front of vehicle 300 and therefore may operate functions primarily for the right portion of vehicle 300.

As shown in FIG. 2B, ECU 20 may operate functions 1, functions 2, functions 3, or functions 4. Functions 1 may include functions such as front suspension valves, or autonomy control module, among other things. Functions 4 may include functions such as steering angle sensor, front wiper motor, left door latches, left headlamp, exterior near field communication (NFC), or on-board diagnostics (OBD) port, among other things. Functions 1 or functions 2 may include functions such as electric power assisted steering (EPAS), charge port door, interior NFC, or electric powered assisted breaking, among other things. In this example, functions 1, functions 2, functions 3, or functions 4 of ECU 20 may be powered by DCDC 50 (which may be the primary power) or LV battery 60 (which may be the secondary power). ECU 20 may be located on the left front of vehicle 300 and therefore may operate functions primarily for the left portion of vehicle 300.

As shown in FIG. 2B, ECU 30 may operate functions 1, functions 2, and jumpstart functions. ECU 30 may be connected with jumpstart access 17. Jumpstart access 17 may allow an external power source (e.g., jumpstart pack) to connect with ECU 30 in order to jumpstart electronic functions of vehicle 300, such as when LV battery 60 is depleted. As further described herein, jumpstart access 17 may have multiple routes. Functions 6 may include functions such as main contactor or DCFC contactor. Functions 7 or functions 8 may include functions such as rear vehicle access system sensors, liftgate latch, trailer brake, right lamp rear, left lamp rear, right trailer brake lamp, rear suspension valves, DCDC logic power, BMS voltage/isolation monitoring, park lock, HV pack shunt monitor, radio farm, chargeport PC/JO, rear radar, or ethernet components, among other things. In this example, functions 6, functions 7, or functions 8 of ECU 30 may be powered by DCDC 50 (which may be the primary power) or LV battery 60 (which may be the secondary power). ECU 30 may be located on the rear of vehicle 300 (e.g., under a rear seat) and therefore may operate functions primarily for the rear portion of vehicle 300.

System 100 of FIG. 2B may include a battery management system (BMS). BMS may be located at or near HV battery pack 310, which LV DCDC 41 converts the HV DC to a lower voltage, such as 14V. LV DCDC 41 may help reduce the need for LV battery 60 for some operations, such as when vehicle 300 is in standby mode (e.g., parked). It is contemplated that the functions disclosed herein (e.g., functions 1 through functions 8) may be controlled by other ECUs or powered by any of the listed power sources.

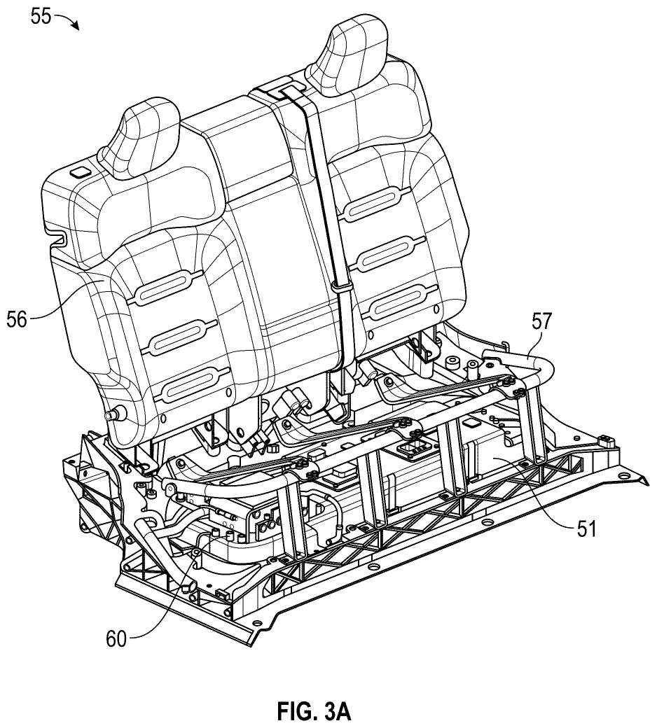

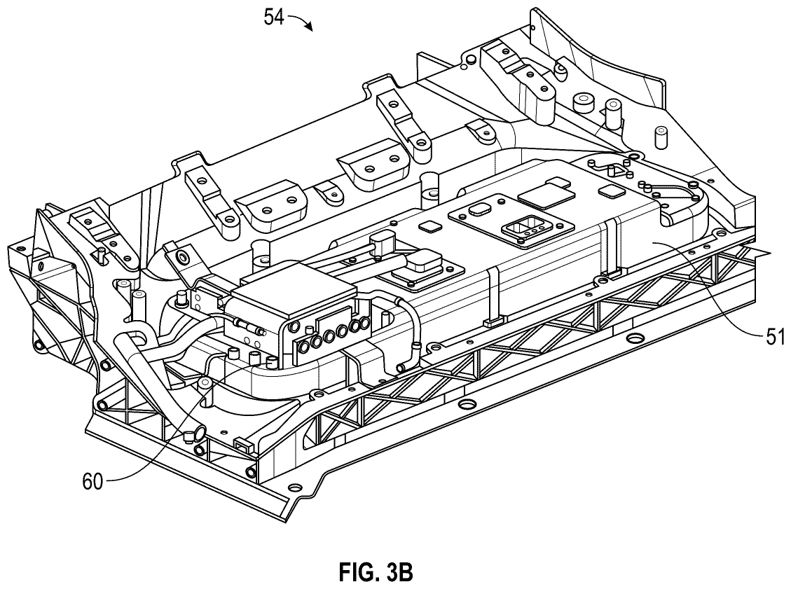

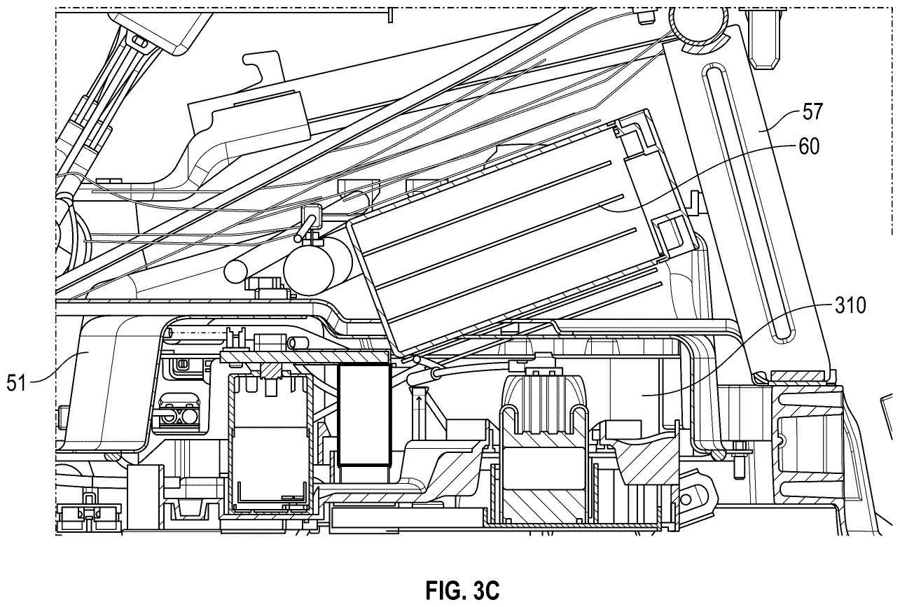

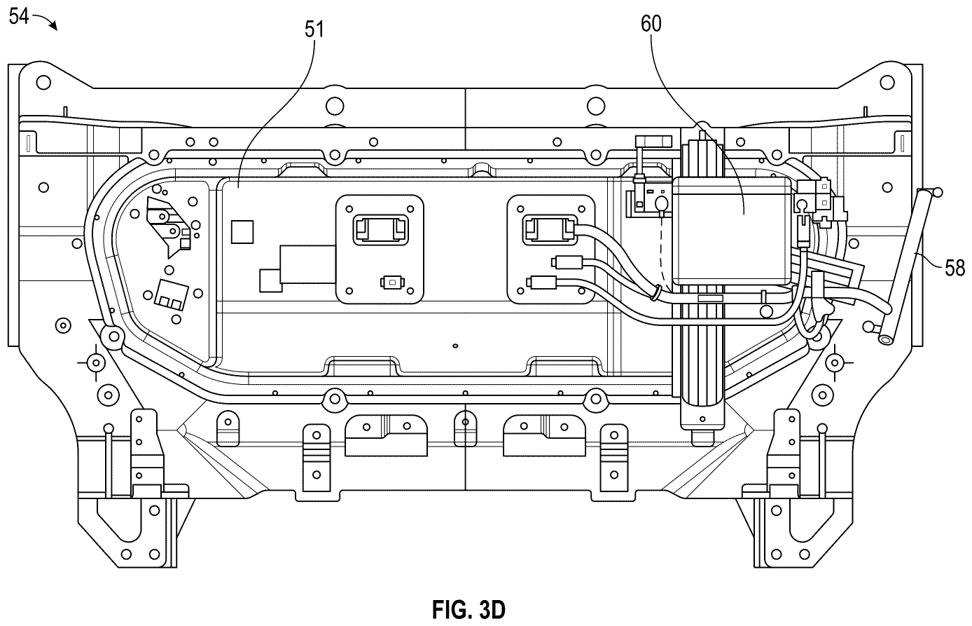

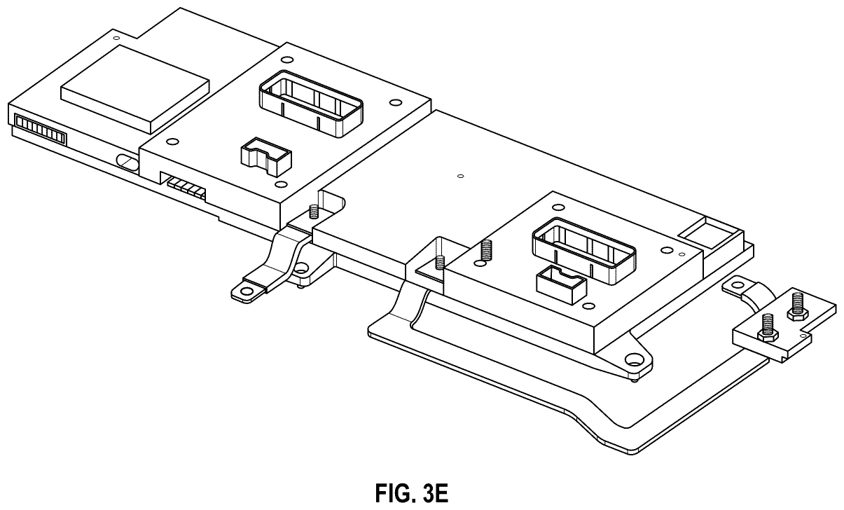

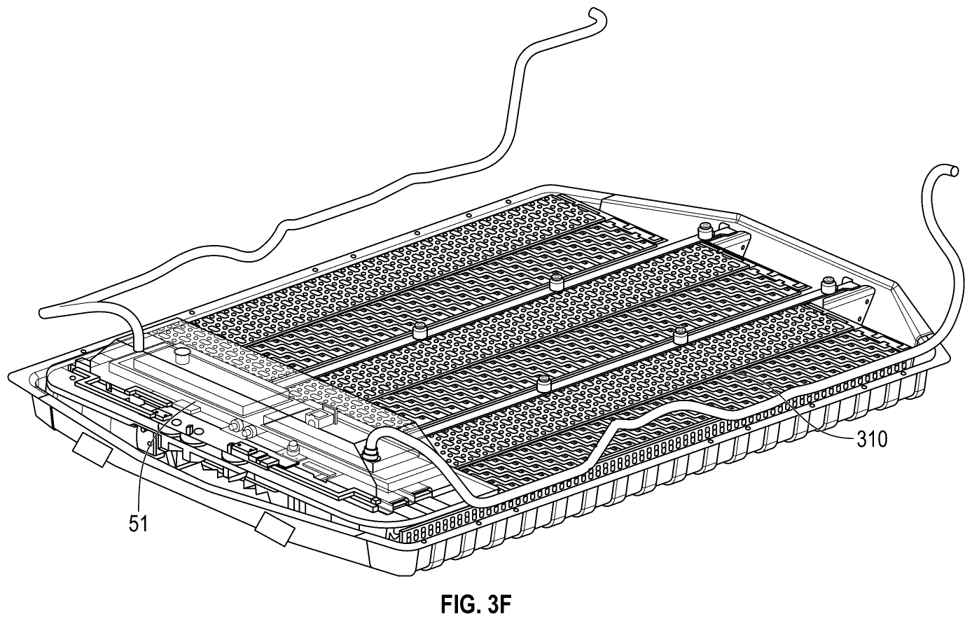

FIG. 3A illustrates an exemplary perspective cross-sectional view of a rear seat assembly 55 of vehicle 300 and the power management compartment 51 component. Power management compartment 51 may be located under the rear seat assembly 55 of vehicle 300, such as under one or more seats 56.

Power management compartment 51 may be rectangular or other shaped structure that houses electrical components such as ECU 30, DC-DC 50, or other sophisticated power management systems. Power management compartment 51, as shown, may be flanked by structural components 57 of rear seat assembly 55 for protecting power management compartment 51 or support seating elements, such as cushions. Structural components 57 may serve as mounting brackets and structural supports, power management compartment 51 remains secure during vehicle operation.

LV battery 60 may abut power management compartment 51 and may be angled in a position that maximizes space utilization, minimizes the likelihood of altering a passengers seating comfort, and maintain accessibility for maintenance. The assembly may be mounted on the floor pan of vehicle 300.

The packaging assembly associated with power management compartment 51 illustrates the integration of critical systems beneath passenger areas, optimizing space usage while ensuring easy access for maintenance and upgrades.

FIG. 3B illustrates an exemplary perspective cross-sectional view of the rear assembly associated with power management compartment 51. The rear assembly 54 includes power management compartment 51, LV battery 60, connector 58, and connectors from terminals of LV battery 60 to corresponding terminals of power management compartment 51, such as ECU 30.

FIG. 3C illustrates an exemplary side cross-sectional view of the rear assembly associated with power management compartment 51, which provides insight into the spatial relationships between the power management compartment 51 components and the seating structure of vehicle 300. LV battery 60 may be positioned at an angle, confirming the space-optimizing design described herein. One or more components of power management compartment 51, such as ECU 30 DC-DC 50, or other power management systems, may be connected with HV pack 310. FIG. 3D illustrates an exemplary top-down view of the rear assembly 54 which include power management compartment 51 integrated into the floor structure of vehicle 300, which includes wiring that may connect with ECU 10. FIG. 3E is an exemplary implementation of a flexible busbar with connectors that may be used with power management compartment 51. This flexible busbar may reduce concerns regarding flexing a large cable. It also means that the resistance of that chain is very well controlled, so there can be sensing and monitoring of LV battery health more effectively. If this busbar is used than temperature sensor may be integrated and may potentially reduce the number of fuses because a reduce likelihood of shorts. FIG. 3F illustrates an exemplary schematic representation of the power distribution system, which include HV pack 310 and power management compartment 51. Components of power management compartment 51 connect with vehicle's HV pack 310.

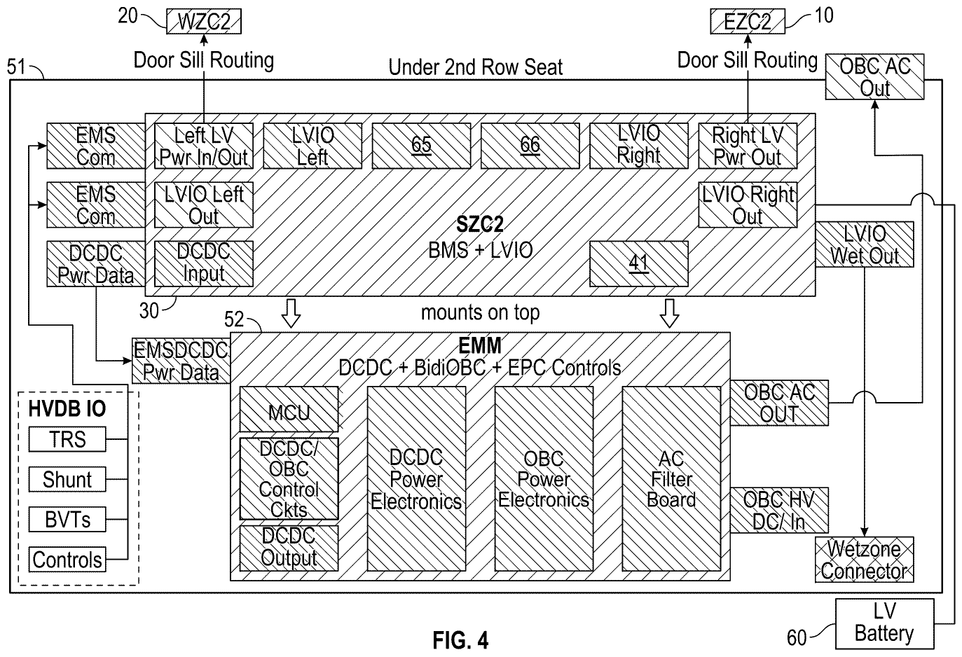

FIG. 4 illustrates an exemplary zonal architecture with a power management compartment 51. In this example, ECU 30, which may be located in the rear of vehicle 300, may be mounted on top of EMM 52. ECU 30 may include functions associated with BMS, HV functions, or LV functions, among other things. EMM 52 may include DCDC 50 among other power electronics related components.

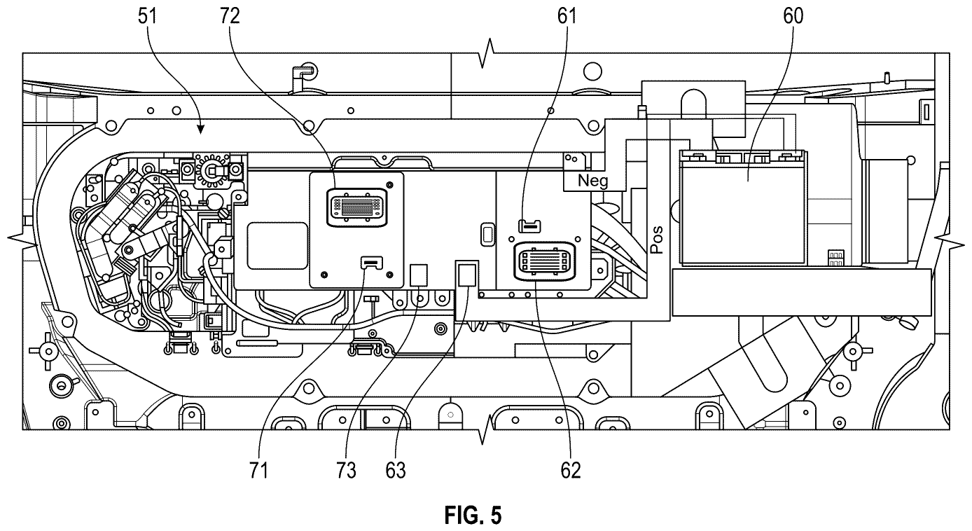

FIG. 5 illustrates an exemplary configuration of power management compartment 51. As shown, connectors may be positioned in a certain manner to help accommodate routing of wires and connections to components. In this example, body connector 62 is placed in the shown position near rear plan of LV battery 60. This positioning may assist with the routing of wiring and reduce the bending needed to maneuver around LV battery 60. FIG. 5 further illustrates example positioning of EZC power connector 61 (e.g., connects to ECU 10), LV battery input connector 63 (e.g., connects positive terminal of LV battery 60), body connector 72, WZC power connector 71 (e.g., connects to ECU 20), DCDC connector 73 (e.g., connects with DCDC 50).

Power management compartment 51 incorporates design features that may optimize space usage and component integration. LV battery 60 may be positioned at an angle within the power management compartment 51, allowing for efficient nesting of the battery between other components and reducing the likelihood that LV battery 60 will affect the seating comfort of a passenger. This angled orientation may maximize space utilization while maintaining accessibility for servicing.

The system features an energy management and control unit (EMCU) that combines SZC 30 with the Energy Management Module (EMM) 52. This integration reduces mass and cost by sharing a common enclosure while allowing for tighter integration between components. By eliminating separate covers for components and integrating them into a single unit, the overall Z-height of power management compartment 51 is reduced. This not only improves packaging efficiency but also enhances passenger safety and comfort by reducing the risk of contact between the seat and the underlying electronics during vehicle operation or in crash scenarios.

LV battery 60 may be directly connected to the central ECU 30, eliminating the need for separate voltage sense lines, fuses, and ground studs. This direct connection strategy may improve accuracy in voltage and current monitoring while reducing parts count and simplifying assembly. There may be examples in which LV battery 60, DC-DC converter 50, and central ECU 30 may share a common ground within power management compartment 51. This unified grounding approach may improve electromagnetic compatibility (EMC) and may allow for more accurate voltage sensing and current monitoring.

Power management compartment 51 architecture may allow for easy access to LV battery 60 for servicing. By simply lifting the second-row seat cushion, maintenance personnel can access LV battery 60 without the need to remove multiple fasteners or disassemble other components. The central ECU 30 may incorporate battery monitoring functions previously handled by separate sensors. This integration eliminates the need for dedicated battery monitoring hardware, reducing system complexity and cost. ECU 30 directly measures battery voltage, current, and temperature, providing more accurate and reliable battery health monitoring.

By centralizing these critical components in the power management compartment architecture, the disclosed subject matter may improve electrical performance and reliability and may also contribute to enhanced vehicle dynamics and passenger comfort through optimized weight distribution and reduced intrusion into the passenger space.

This vehicle design may incorporate a rear centralized zonal architecture, featuring an ECU 30 (e.g., south zone controller (SZC)) housed in a protected rear centralized zonal architecture with a “treehouse” structure (e.g., power management compartment 51) in a crash protected area of vehicle 300, such as beneath the second row seat. A crash-protected area of a vehicle refers to specific zones within the vehicle that are designed to offer the highest level of protection during a collision. ECU 30 may act as the core of the electrical system of vehicle 300, integrating high voltage battery management, LV battery management, power distribution control, or rear body control functions. This approach may significantly reduce wiring complexity by decreasing the number of high current power feeds from seven or more to just three main feeds, for example: the DC-DC converter output to ECU 30, ECU 30 to ECU 20, and ECU 30 to ECU 10. This reduction in wiring not only decreases the overall weight of vehicle 300 but may simplify the manufacturing process, enhance reliability by reducing potential failure points, or minimize electromagnetic interference issues.

The rear centralized zonal architecture may provide enhanced crash safety by shielding critical components from front, rear, or side impacts. This centralized location of components reduces the likelihood of damage to multiple systems simultaneously in severe crash scenarios, potentially improving occupant safety and post-crash response capabilities. Power management compartment 51 may be in an area reinforced with strong structural components to absorb and dissipate impact energy, minimizing injury to occupants (and secondarily power management compartment 51).

Thermal management may be efficient through the centralization of high-power components. A single, high-efficiency cooling loop may service the high-power components in Power management compartment 51, enhancing overall cooling efficiency and reducing the complexity associated with multiple separate cooling systems. For example, a location under the second row seat may allow for airflow management, contributing to overall thermal management without significant additional hardware.

Serviceability may be enhanced with core components accessible from a single location, simplifying maintenance and repairs. As disclosed herein, the centralized serviceability allows for modular design with components designed as replaceable modules for simpler maintenance and potential upgrades. By relocating components traditionally placed in the front of the vehicle (e.g., LV battery 60 or DCDC 50) to the rear power management compartment 51, this architecture may allow for a larger front trunk area, enhancing the utility of vehicle 300 and offering more flexibility in front-end design.

The methods, systems, or apparatuses disclosed herein may be incorporated into electric vehicles or other devices. The circuit blocks disclosed herein may be distributed with or combined with one or more ECUs or other devices. The methods, systems, or apparatuses disclosed herein may be incorporated into products, such as various feature specific or zone specific electronic control units (ECUs). The information (e.g., voltage, current, resistance, or proposed functionality), as disclosed herein in the figures and text, is provided for illustrative purposes and other scenarios are contemplated herein.

Systems, methods, and apparatuses related to integrated power management for electric vehicles are disclosed herein. An integrated power management system for an electric vehicle may include a power management compartment located in a rear portion of the vehicle. The power management compartment may include a central electronic control unit (ECU) integrating battery management system functions and zonal control functions, and an energy management module (EMM) comprising a DC-DC converter. The power management compartment may include positioning under a second row seat or third row seat of the vehicle. The power management compartment further may include an integrated energy management and control unit (EMCU) that combines the central ECU and the EMM in a shared enclosure. The system may include a front left ECU and a front right ECU communicatively connected with the central ECU of the power management compartment. The central ECU manages power distribution between a DC-DC bus provided by the DC-DC converter and a battery bus connected with the LV battery. The LV battery positions at an angle within the power management compartment and configured for nesting between other components. The LV battery operates in a range of 9V to 16V. All combinations, including additions and removals of components and steps described in this paragraph and the above paragraphs, are contemplated in a manner consistent with other portions of the detailed description.

A method of assembling an integrated power management system in an electric vehicle may include installing a power management compartment under a second-row seat of the vehicle, positioning a low voltage (LV) battery abutting the power management compartment, integrating a central electronic control unit (ECU) and an energy management module (EMM) into a shared enclosure within the power management compartment, and directly connecting the positive terminal and negative terminal of the LV battery to the respective positive terminal and negative terminal of the central ECU. The power management compartment may include positioning under a second row seat or third row seat of the vehicle. The power management compartment further may include an integrated energy management and control unit (EMCU) that combines the central ECU and the EMM in a shared enclosure. The central ECU may manage power distribution between a DC-DC bus provided by the DC-DC converter and a battery bus connected with the LV battery. The LV battery may be positioned at an angle within the power management compartment and may allow for nesting between other components. The LV battery may operate in a range of 9V to 16V. All combinations, including additions and removals of components and steps described in this paragraph and the above paragraphs, are contemplated in a manner consistent with other portions of the detailed description.

A power management compartment located in a rear portion of the vehicle may include a central electronic control unit (ECU) integrating battery management system functions and zonal control functions, and an energy management module (EMM) including a DC-DC converter. The power management compartment may include positioning under a second row seat or third row seat of the vehicle. The power management compartment further may include an integrated energy management and control unit (EMCU) that combines the central ECU and the EMM in a shared enclosure. The system may include a front left ECU and a front right ECU communicatively connected to the central ECU of the power management compartment. The central ECU may manage power distribution between a DC-DC bus provided by the DC-DC converter and a battery bus connected to the LV battery. The LV battery may be positioned at an angle within the power management compartment and may allow for nesting between other components. The LV battery may operate in a range of 9V to 16V. All combinations, including additions and removals of components and steps described in this paragraph and the above paragraphs, are contemplated in a manner consistent with other portions of the detailed description.

The term “or” is used inclusively unless otherwise disclosed. As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

When an element is referred to herein as being “connected” or “coupled” to another element, it is to be understood that the elements can be directly connected to the other element, or have intervening elements present between the elements. In contrast, when an element is referred to as being “directly connected” or “directly coupled” to another element, it should be understood that no intervening elements are present in the “direct” connection between the elements. However, the existence of a direct connection does not exclude other connections, in which intervening elements may be present.

The predicate words “configured to”, “operable to”, and “programmed to” do not imply any particular tangible or intangible modification of a subject, but, rather, are intended to be used interchangeably. In one or more implementations, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

The word “exemplary” is used herein to mean “serving as an example, instance, or illustration”. Any embodiment described herein as “exemplary” or as an “example” is not necessarily to be construed as preferred or advantageous over other embodiments. Furthermore, to the extent that the term “include”, “have”, or the like is used in the description or the claims, such term is intended to be inclusive in a manner similar to the term “comprise” as “comprise” is interpreted when employed as a transitional word in a claim.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112, sixth paragraph, unless the element is expressly recited using the phrase “means for” or, in the case of a method claim, the element is recited using the phrase “step for”.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but are to be accorded the full scope consistent with the language claims, wherein reference to an element in the singular is not intended to mean “one and only one” unless specifically so stated, but rather “one or more”. Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the subject disclosure.

What is claimed is:

1. An integrated power management system for a vehicle, comprising:
a power management compartment located in a rear portion of the vehicle, wherein the power management compartment comprises:
a central electronic control unit (ECU) integrating battery management system functions and zonal control functions; and
an energy management module (EMM) comprising a direct current to direct current (DC-DC) converter.

2. The integrated power management system of claim 1, wherein the power management compartment is located under a second row seat or third row seat of the vehicle.

3. The integrated power management system of claim 1, wherein the power management compartment further comprises an integrated energy management and control unit (EMCU) that combines the central ECU and the EMM in a shared enclosure.

4. The integrated power management system of claim 1, further comprising a front left ECU and a front right ECU communicatively connected with the central ECU of the power management compartment.

5. The integrated power management system of claim 1, wherein the central ECU manages power distribution between a DC-DC bus provided by the DC-DC converter and a battery bus connected with a low voltage (LV) battery.

6. The integrated power management system of claim 5, wherein the LV battery positioned at an angle within the power management compartment and configured to nest between other components.

7. The integrated power management system of claim 5, wherein the LV battery operates in a range of 9V to 16V.

8. A method of assembling an integrated power management system in an electric vehicle, comprising:
installing a power management compartment under a second-row seat of the vehicle;
positioning a low voltage (LV) battery abutting the power management compartment;
integrating a central electronic control unit (ECU) and an energy management module (EMM) into a shared enclosure within the power management compartment; and
directly connecting a positive terminal and a negative terminal of the LV battery to a respective positive terminal and a negative terminal of the central ECU.

9. The method of claim 8, wherein the power management compartment is located under a second row seat or third row seat of the vehicle.

10. The method of claim 8, wherein the power management compartment further comprises an integrated energy management and control unit (EMCU) that combines the central ECU and the EMM in a shared enclosure.

11. The method of claim 8, wherein the central ECU manages power distribution between a direct current to direct current (DC-DC) bus provided by the DC-DC converter and a battery bus connected to the LV battery.

12. The method of claim 8, wherein the LV battery positioned at an angle within the power management compartment and configured to nest between other components.

13. The method of claim 8, wherein the LV battery operates in a range of 9V to 16V.

14. A power management compartment located in a rear portion of a vehicle, wherein the power management compartment comprises:
a central electronic control unit (ECU) integrating battery management system functions and zonal control functions; and
an energy management module (EMM) comprising a direct current to direct current (DC-DC) converter.

15. The power management compartment of claim 14, wherein the power management compartment is located under a second row seat or third row seat of the vehicle.

16. The power management compartment of claim 14, wherein the power management compartment further comprises an integrated energy management and control unit (EMCU) that combines the central ECU and the EMM in a shared enclosure.

17. The power management compartment of claim 14, further comprising a front left ECU and a front right ECU communicatively connected to the central ECU of the power management compartment.

18. The power management compartment of claim 14, wherein the central ECU manages power distribution between a DC-DC bus provided by the DC-DC converter and a battery bus connected with a low voltage (LV) battery.

19. The power management compartment of claim 18, wherein the LV battery positioned at an angle within the power management compartment and configured to nest between other components.

20. The power management compartment of claim 18, wherein the LV battery operates in a range of 9V to 16V.
